(19) United States
(12) Patent Application Publication
(10) Pub. No.: US 2012/0156347 A1
(43) Pub. Date: Jun. 21, 2012

(54) Cookie Shaping Device

(75) Inventors: Barbara Perlin, Los Angeles, CA (US); Henner Jahns, Los Angeles, CA (US)

(73) Assignee: Monkey Wear, LLC

(21) Appl. No.: 13/237,784

(22) Filed: Sep. 20, 2011

Related U.S. Application Data
(60) Provisional application No. 61/481,635, filed on May 2, 2011.
(60) Provisional application No. 61/424,522, filed on Dec. 17, 2010.

(51) Int. Cl. A21C 9/00; A21D 6/00; A23P 1/00

(52) U.S. Cl. 426/502; 99/450.2

(57) ABSTRACT

A cookie folding device for folding food to a desired shape. One embodiment of the cookie folding device includes a base, a center ridge and two arms. The arms pivot downwards, causing a cookie to bend around the arms and over the center ridge.

### RELATED APPLICATIONS

This application claims priority to U.S. Provisional Application Ser. No. 61/481,635 filed May 2, 2011 entitled Cookie Shaping Device, and U.S. Provisional Application Ser. No. 61/424,522 filed Dec. 17, 2010 entitled Cookie Shaping Device, both of which are hereby incorporated herein by reference.

### BACKGROUND OF THE INVENTION

It is often desirable to cut or shape food to improve aesthetics, edibility and even taste. Some food shapers, such as cookie cutters, provide a mechanism to impart a relatively simple, two-dimensional shape to a cookie.

Food shapes of greater complexity often require more complex shaping equipment. For example, fortune cookies are traditionally shaped by precisely folding a cookie in a first direction, then partially folding the cookie in a perpendicular direction. This dual folding can be difficult to achieve without the aid of a shaping device.

Most fortune cookie shaping devices are relatively large, complicated machines, such as those seen in U.S. Pat. Nos. 4,138,938 and 4,431,396, the contents of which are hereby incorporated by reference. While these machines may function adequately for large, industrial purposes, they are not practical for use in most home kitchens or restaurants.

### SUMMARY OF THE INVENTION

A preferred embodiment of the present invention comprises a food shaping device for shaping food in a complex shape. The food shaping device may be particularly useful for folding cookies into a traditional fortune cookie shape (i.e., a circular cookie folded along a first direction and then folded along a second, generally perpendicular direction. The shaping device generally includes a first, center blade (or ridge) and two arms on opposing sides of the blade. The arms can be moved along a downwardly-arcing path so as to force the cookie into a shaped insert within the device, thereby creating the first fold. This downward movement of the arms also pulls the cookie across the center blade, thereby forming the second cookie fold.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 illustrates a perspective view of a food shaping device according to the present invention.

Figure illustrates a top view of the food shaping device of FIG. 1.

FIGS. 3 and 4 illustrate perspective views of arms of the food shaping device of FIG. 1.

FIG. 5 illustrates a top view of the food shaping device of FIG. 1.

FIG. 6 illustrates a side view of the food shaping device of FIG. 1.

FIG. 7 illustrates an exploded view of the food shaping device of FIG. 1.

FIG. 8 illustrates a perspective view of the food shaping device of FIG. 1.

FIG. 9 illustrates a top view of the food shaping device of FIG. 1 and a cookie.

FIG. 10 illustrates a top view of the food shaping device of FIG. 1 and a cookie.

FIG. 11 illustrates a top view of the food shaping device of FIG. 1 and a cookie.

FIG. 12 illustrates a perspective view of the food shaping device of FIG. 1 and a cookie.

FIGS. 13A-14 illustrate a cookie pan according to the present invention.

FIG. 15 illustrates a top perspective view of a food shaping device according to the present invention.

FIG. 16 illustrates a bottom view of the food shaping device of FIG. 15.

FIG. 17 illustrates a bottom view of the food shaping device of FIG. 15.

FIG. 18 illustrates several gear components of the food shaping device of FIG. 15.

FIG. 19 illustrates several gear components of the food shaping device of FIG. 15.

FIG. 20 illustrates a top perspective view of a food shaping device according to the present invention.

FIG. 21 illustrates a side view of a food shaping device according to the present invention.

FIG. 22 illustrates a side perspective view of a food shaping device according to the present invention.

FIG. 23 illustrates a top view of the food shaping device of FIG. 22.

FIG. 24 illustrates an exploded view of the food shaping device of FIG. 21.

FIG. 25 illustrates a perspective view of the food shaping device of FIG. 21 in various states of use.

FIG. 26 illustrates a food shaping device according to the present invention.

FIG. 27 illustrates a top view of the food shaping device of FIG. 26.

FIG. 28 illustrates a bottom view of the food shaping device of FIG. 26.

FIG. 29 illustrates an exploded view of the food shaping device of FIG. 26.

FIG. 30 illustrates an exploded view of the food shaping device of FIG. 26.

FIG. 31 illustrates a partially disassembled view of the food shaping device of FIG. 26.

FIG. 32A illustrates a perspective view of the bowl of the food shaping device of FIG. 26.

FIG. 32B illustrates an interior view of the bowl of the food shaping device of FIG. 26.

FIG. 32C illustrates an enlarged view of a groove in the bowl of the food shaping device of FIG. 26.

FIG. 33 illustrates a frame member of the food shaping device of FIG. 26.

FIGS. 34 and 35 illustrate arm members of the food shaping device of FIG. 26.

FIGS. 36A and 36B illustrates arm members of the food shaping device of FIG. 26.

FIGS. 37A and 37B illustrates a contoured shaping insert of the food shaping device of FIG. 26.

FIGS. 38A and 38B illustrates contoured shaping insert of the food shaping device of FIG. 26.

FIGS. 39-42 illustrate various positions of the food shaping device of FIG. 26.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

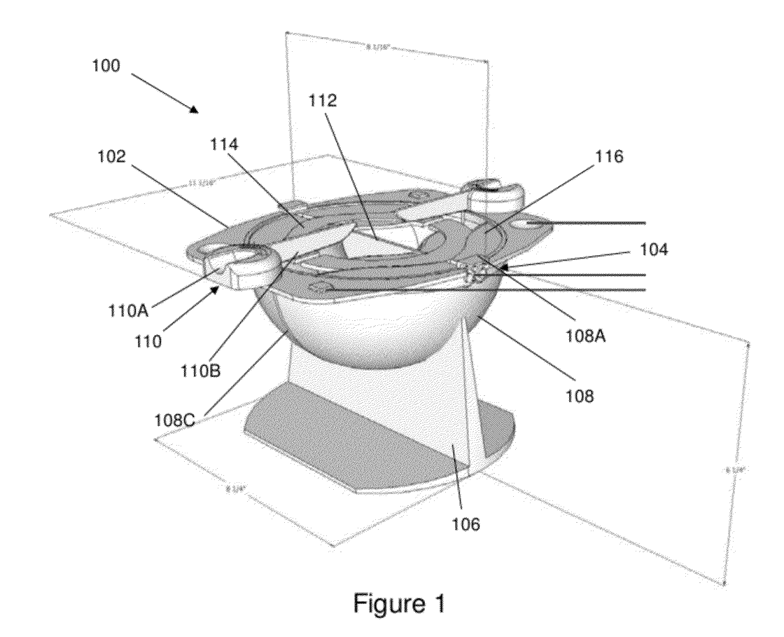

FIGS. 1-12 illustrate various views of an embodiment of a food shaping device 100 according to the present invention that allows a user to reliably and repeatedly shape a thin portion of food. In one example, the device 100 can be used to fold and shape a warm cookie into a traditional fortune cookie shape (i.e., a circular shape having a fold along a first direction and a fold along a second direct, perpendicular to the first). Since the traditional fortune cookie shape can be difficult to satisfactory and repeatedly make by hand, the shaping device 100 allows for a more consistent and aesthetically pleasing fortune cookie shape. While the device 100 is described herein for use with making fortune cookies, it should be understood that the device 100 can be used with a variety of different shapeable foods and can be modified to achieve different shapes.

As discussed in greater detail below, the user places a warm cookie on the top of the device 100. The user depresses two arms 110 that cause the cookie to bend around the blade 110B of each arm 110 in a first direction and around a middle blade 112 to cause a second bend that is perpendicular to the first. In this respect, the same fortune cookie shape can be easily repeated by a user.

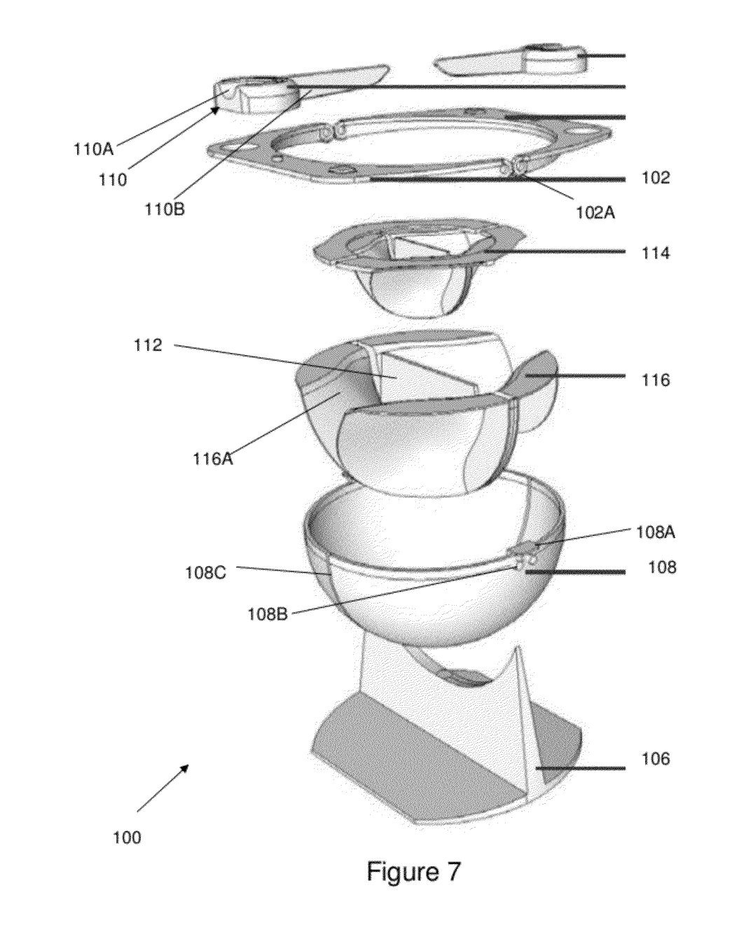

As best seen in FIG. 7, the device 100 comprises a base 106 having a lower flat portion for providing stability on a flat surface. An upper region of the base 106 includes a generally curved region that is sized and shaped to fit with the underside of bowl 108. Preferably, an attachment mechanism, such as a screw or latch, is located in the curved region and is connectable to the underside of the bowl 108.

The bowl 108 has a generally concave or bowl-like shape and faces upward from the base 106 (i.e., the opening of the bowl 108 faces upwards relative to the base 106). A large cookie insert 116 sits within and preferably removably locks into the bowl 108. The interior of the large insert 116 includes the middle blade 112 that extends across the length of the large insert 116.

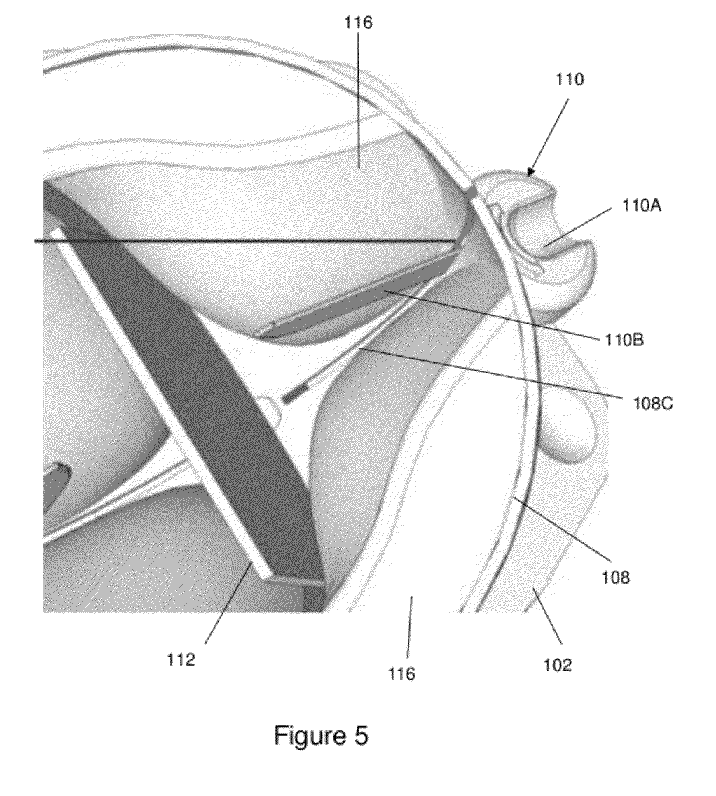

The large insert 116 also includes contoured surfaces 116A which are shaped to assist the cookie in folding around the blades 110B as the blades 110B push areas of the cookie downward into the bowl 108. Preferably, the contoured surfaces 116A are generally wider near the middle blade 112 and narrow towards the arms 110. Additionally, the surfaces 116A are generally wider near the top of the device 100 and become narrower along the depth of the bowl 108. Preferably, the contoured surfaces 116A are rounded, but may alternately have a more linear or planar shape. The outer ends of the arms 110 tend to rotate or arc downwards relative to the free end of the blade 110B during operation (see FIG. 5) and therefore the outer diameter of the cookie tends to be contacted and shaped by the contoured surfaces 116 to a greater extent than the inner or center portions of the cookie.

While described as a blade, the middle blade 112 preferably has a generally rounded edge so as to encourage bending of a cookie or other food instead of breaking or slicing. The middle blade 112 may be of a relatively uniform thickness or may increase in thickness towards the bottom of the bowl 108. This blade 112 may also be considered a ridge, divider, or fold-inducing member. Similarly, the blades 110B have generally rounded edges so as to encourage bending or folding of a cookie instead of breaking or slicing. The blades 110B may also be considered flippers, wings or fold-inducing members.

A medium cookie insert 114 fits within the bowl 108 and has similar internal contoured surfaces and a middle blade as the large insert 116. Preferably, the medium insert 114 replaces the large insert 116 (i.e., the large insert 116 is first removed) to form smaller cookies. In this respect, a variety of insert sizes could be used with the device 100, depending on the size of the cookie to be folded. Alternately, the medium insert 114 may be modified to fit over the large insert 116 such that the large insert 116 can remain in place.

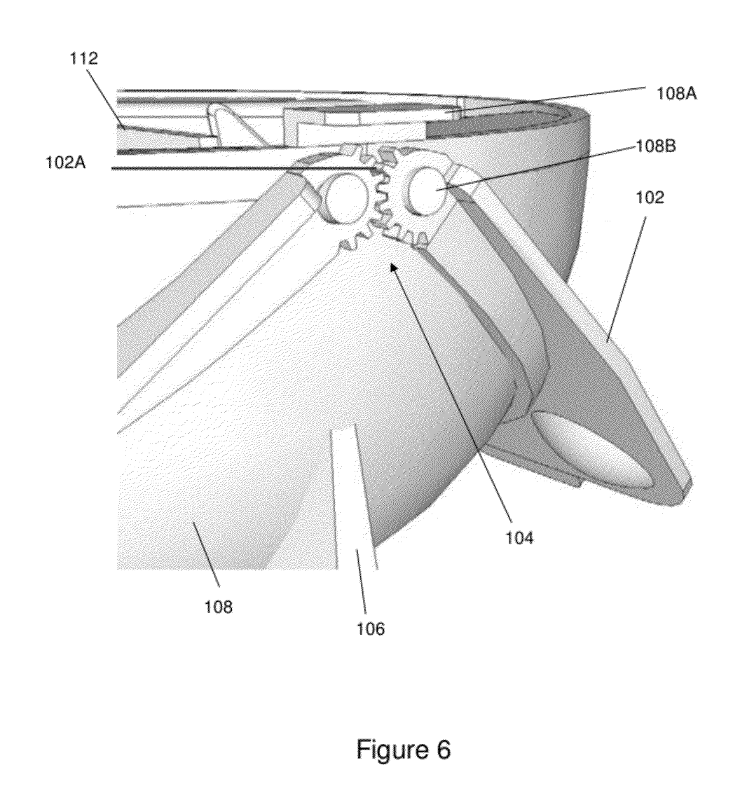

Two frame members 102 are connected to symmetrical outer locations on the bowl 108. As best seen in FIG. 6, each frame member 102 is connected via a geared hinge 104. The geared hinge 104 is comprised of two posts 108B located in close proximity and extending from the outer surface of the bowl 108. The frame members 102 have two arms that each have an aperture that fits over one of the posts 108B, forming the hinge 114. In this respect, each side of the bowl 108 have opposite hinges 114 that allow each frame member 102 to move downward along an arced or curved path.

The movement of the frame members 102 are synchronized via mating gear regions 102A on the ends of each of the arms of the frame members 102. Hence, the gear regions 102A ensure that each frame member 102 bends in unison at a nearly identical angle to the other frame member 102. This synchronous movement allows for move even and symmetrical folding of the cookie. The gear regions 102A are preferably covered with cover 108A to prevent the cookie from being damaged by movement of the gears 102A.

Preferably, the frame member 102 includes a side surface having a curve matching that of the bowl 108. Hence, as the frame members 102 move downward, they are unobstructed by the shape of the bowl 108. Preferably, the frame members 102 can be either locked in the raised, horizontal position or can be biased to that position (e.g., via a spring mechanism).

Two arms 110 are each pivotally positioned on one of the frame members 102 so as to directly oppose each other. The body of the arms 110 include elongated blades 110B and a depression 110A preferably sized for a user's thumb.

It should be understood that the components of the device 100 can be composed of any food safe material, such as metals (e.g., aluminum, stainless steel) or food-grade plastics. Optionally, some components that contact the cookie can include a stick-resistant coating such as Teflon.

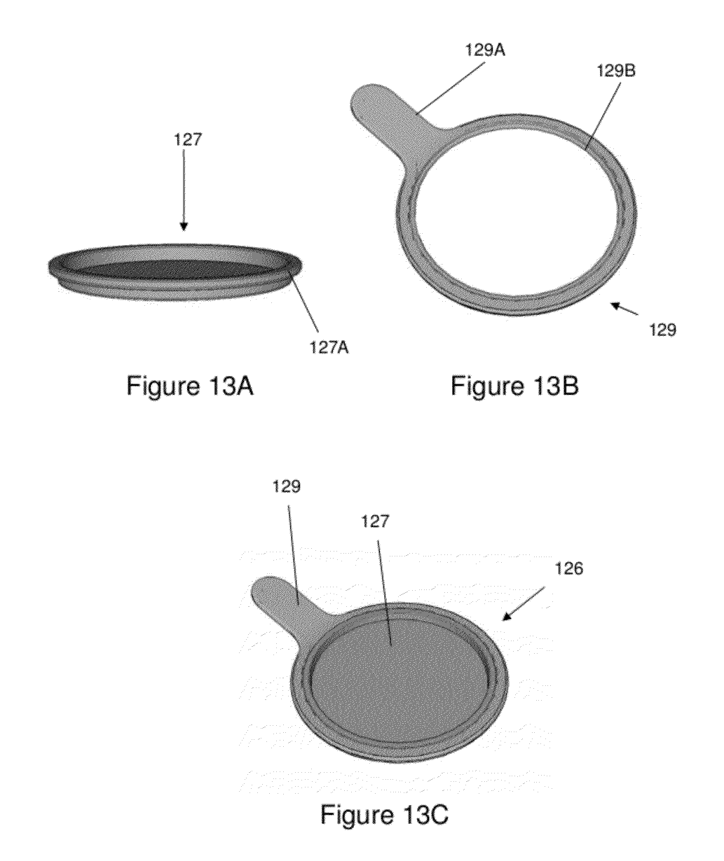

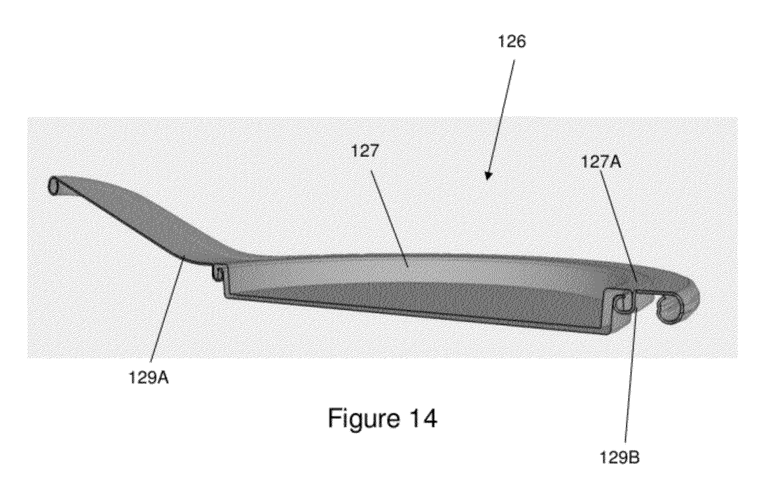

Preferably, the device 100 includes a cookie baking pan 126, seen in FIGS. 13A-14, which has raised side walls that maintain the cookie in a desired diameter suitable for use with either the medium insert 114 or the large insert 116.

In one embodiment, the pan 126 is composed of an inner silicone pan 127 and an outer pan holder 129. The pan holder 129 is preferably composed of a rigid material such as metal or high temperature-resistant plastic and includes a handle 129A for moving the pan 126 during use.

Preferably, the pan holder 129 removably couples to the inner pan 127 via a first lip 127A around the outer diameter of the inner pan 127 and a second lip 129B around the inner diameter of the pan holder 129. As seen best in the cross sectional view of FIG. 14, the first lip 127A is angled downwards (i.e., toward the bottom of the pan 127) and the second lip 129B is angled upwards so as to create a groove large enough to fit the first lip 127A. Alternately, the outer diameter of the pan 127 and the inner diameter of the pan holder 129 can have any type of selectively interlocking or mating shapes that the pan 127 to be removably captured by the pan holder 129.

This pan 126 can be composed of any known baking pan materials, such as metal or silicone. Optionally, a cookie cutter of similar diameter can also be included with the device to assist the user in initially cutting the cookie dough to a desired diameter (i.e., the size of the baking pan 126).

A fortune cookie can be made with the previously described elements as follows. First, a user places a desired amount of cookie dough in the pan 126. This dough can be rolled and pre-cut to the diameter of the pan 126 (e.g., using a cookie cutter) or can be distributed in the pan 126 without any further preparation. This pan 126 is placed in the oven and cooked for a desired period of time.

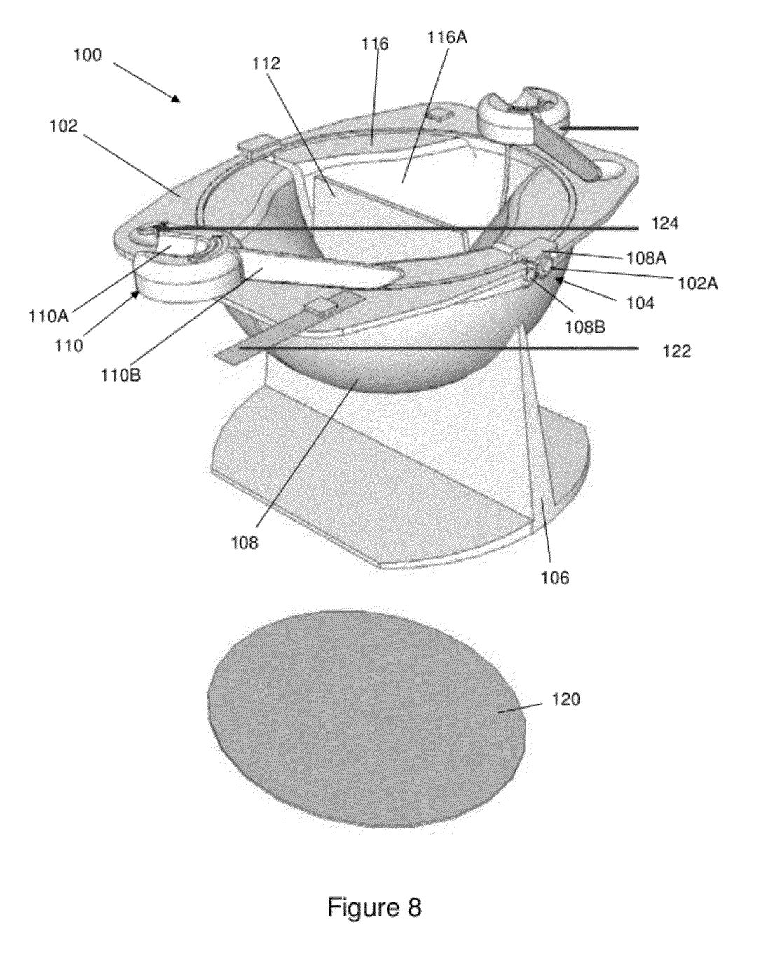

When the cooking has been completed, the pan 126 is removed from the oven, producing cookie 120, seen in FIG. 8. As also seen in FIG. 8, the device is prepared by rotating arms 110 such that the blades 110B no longer cover the bowl 108. If the user wishes to add contents to the inside of the finished fortune cookie, a paper message 122 can be placed in a paper holder on the frame 102 and an item (e.g., a ring 124) can be placed in a small well or divot that is also on the top surface of the frame 102.

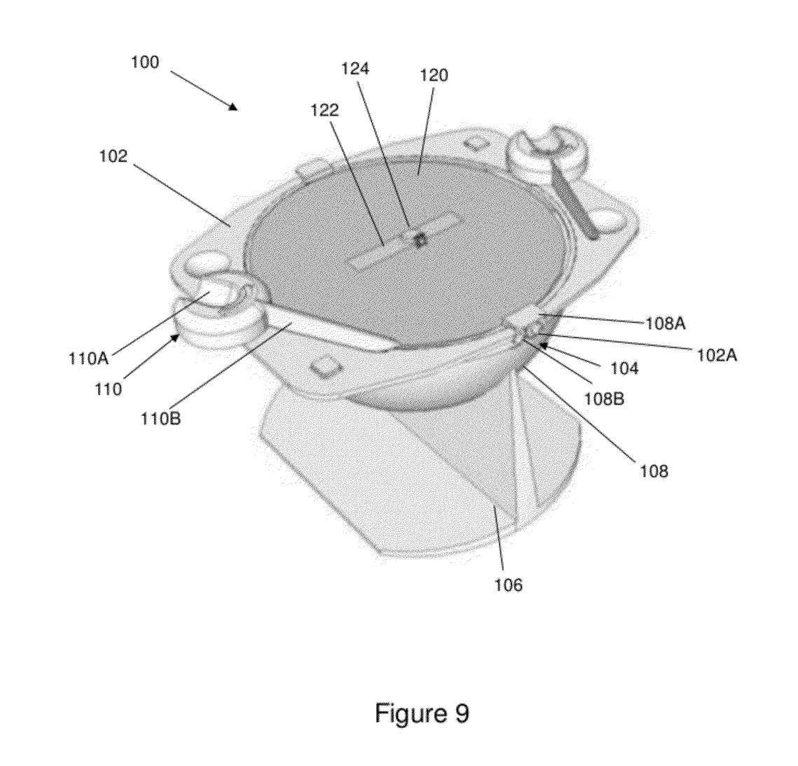

As seen in FIG. 9, the cookie 120 is placed on the top of the device 100 while it is still warm and bendable. The contents the user desires to include in the finished cookie (e.g., message 122 and ring 124) are placed near the center of the cookie 120.

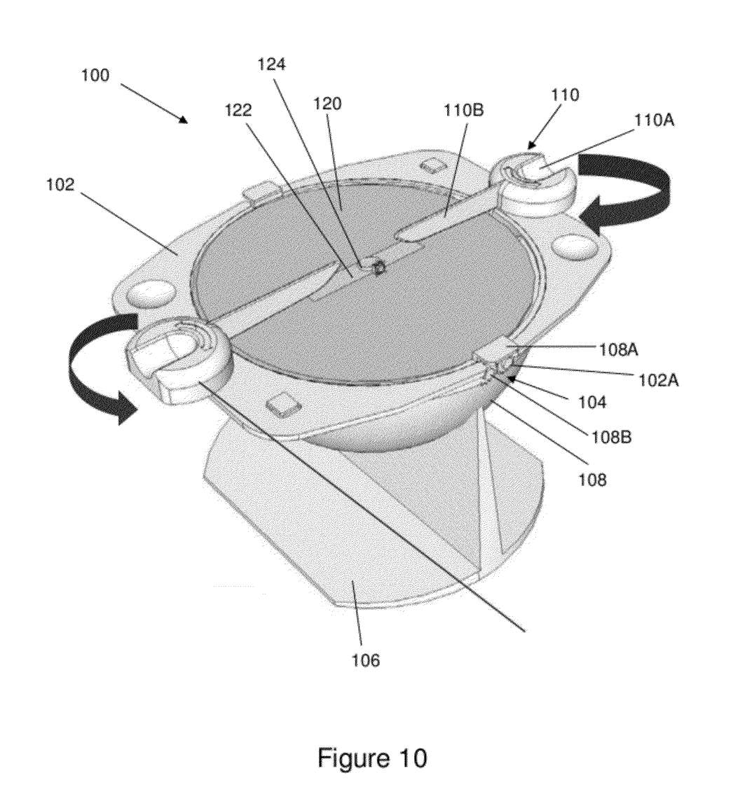

Turning to FIG. 10, the arms 110 are rotated such that the blades 110B are directly opposing each other. The user places their thumbs on the depression 110A and push downward. It should be understood that the arms 110 follow a generally arced path. In other words, the free ends of the blade 110 remain in the same general area but the body of the arms 110 move from a position generally horizontal to the ends of the blade 110 to a position approximately beneath or vertical to the ends. Hence, the arms 110 rotate about their length as the thumb portion 110A generally follows the outer contour of the bowl 108.

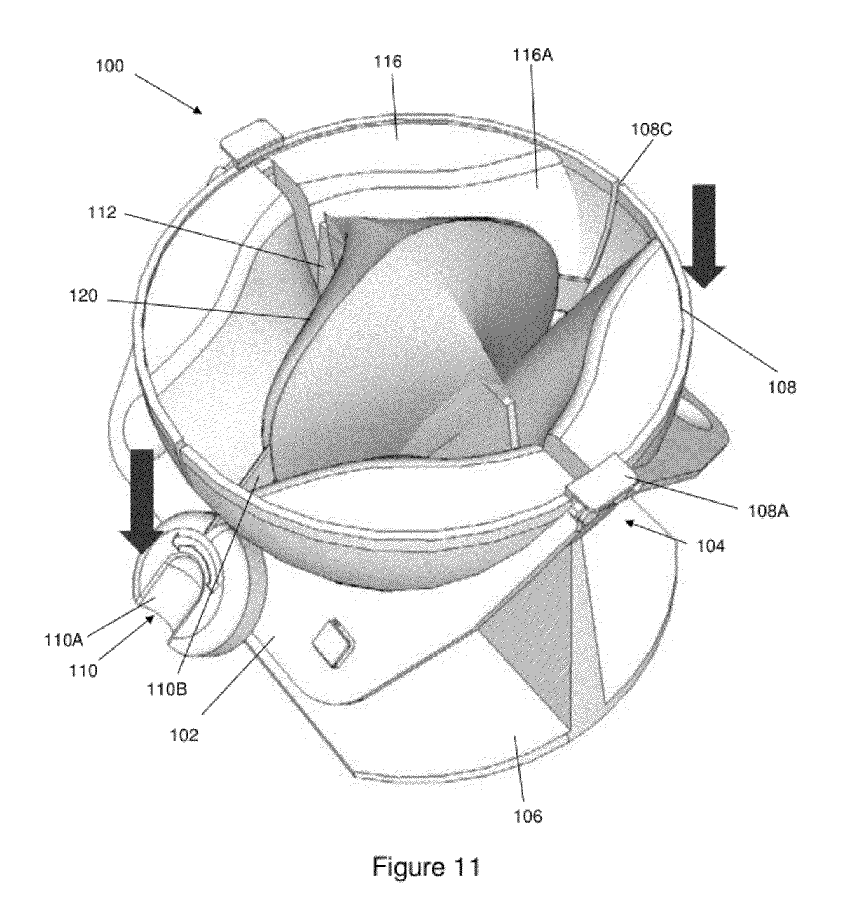

FIG. 11 illustrates the device 100 as the arms 110 and therefore both frame members 102 are pivotally and simultaneously moved downward. The angled, arced and downward motion of the blades 110B cause the cookie 120 to fold around the length of the blades 110B. More specifically, the arms 110 move in a generally arc-shaped path while also rotating such that arm portion 110A moves downward faster than the free end of the blade 110B. In other words, the arms 110 move with a downward motion component (towards the bottom of the bowl 108) and with a rotational component (to form a generally upside-down V shape) as a result of being on attached to the device via a pivoting mechanism (i.e., the frame members 102).

Additionally, this downward movement causes the cookie 120 to fold against the center blade 112. As the user continues to move the blades 110B downward, the contoured surfaces 116A of the insert 116 help maintain the cookie in a desired shape (e.g., larger near the top and narrowed near the bottom).

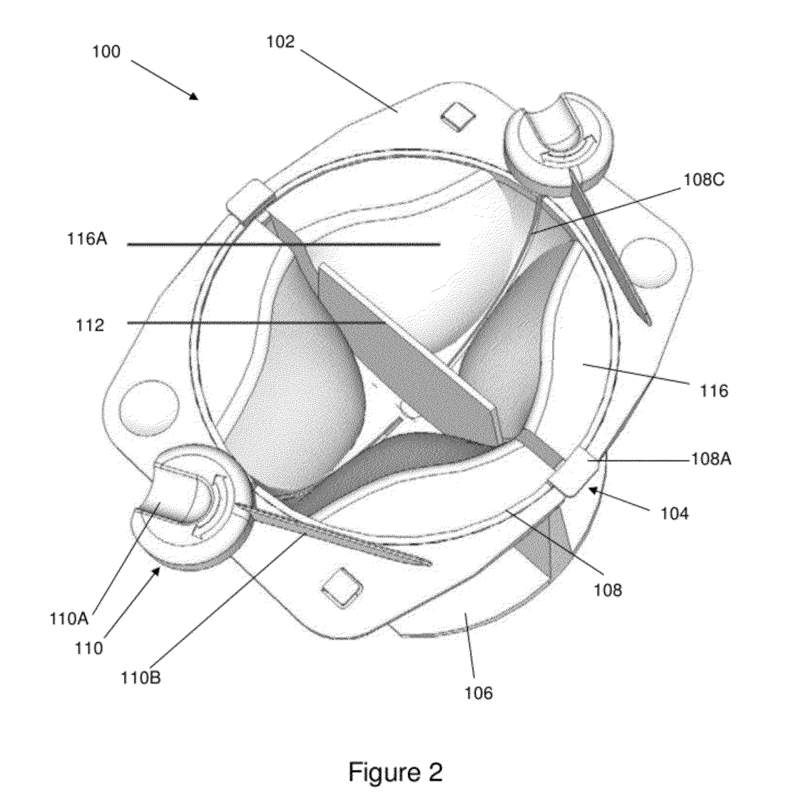

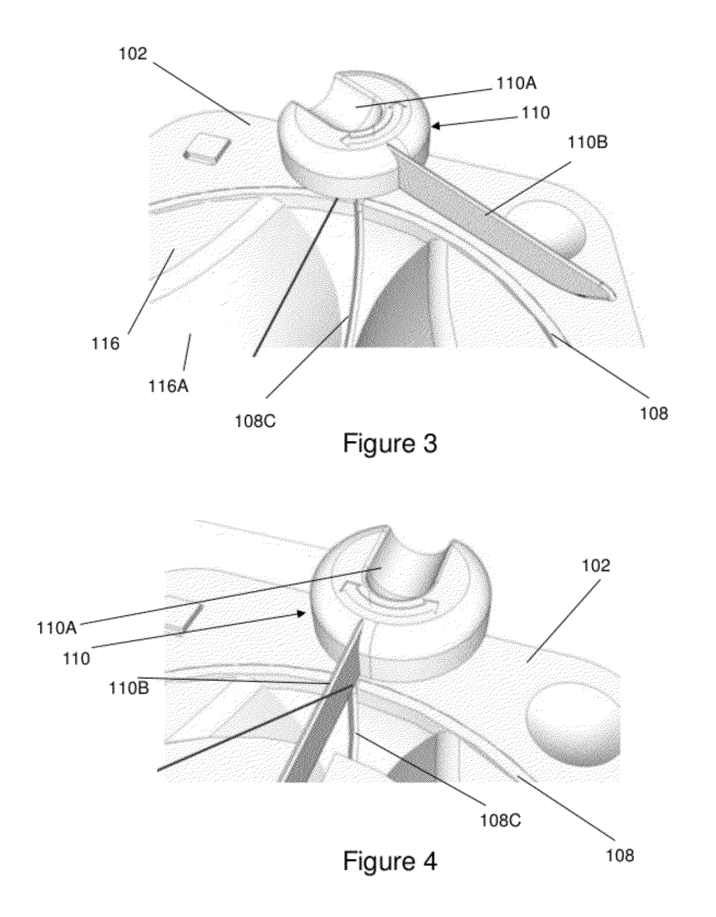

As best seen in FIGS. 3-5, the blade 110B can achieve its downward movement by aligning with and following the slot 108C that is positioned on each side of the bowl 108. This slot 108C also prevents accidental rotation of the arms 110 during the folding process.

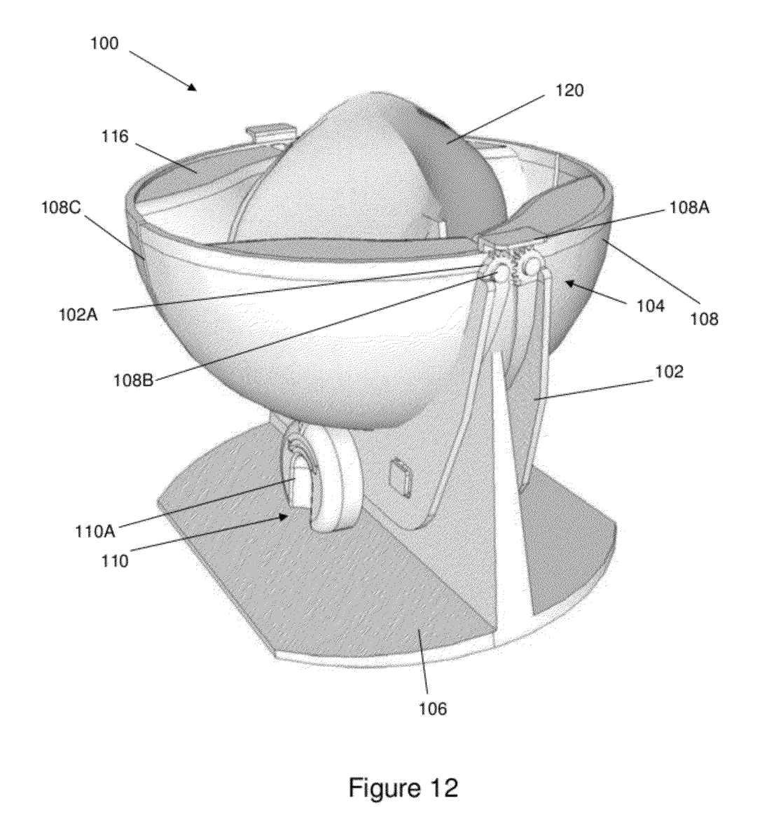

As seen in FIG. 12, the frame members 102 are moved into vertical positions. At this time, the cookie 120 can be left to cool in the device 100. After cooling, the finished cookie 120 can be removed from the device 100. The frame members 102 can be moved back to their original position (i.e., horizontal) and the device 100 can be used for the next warm cookie.

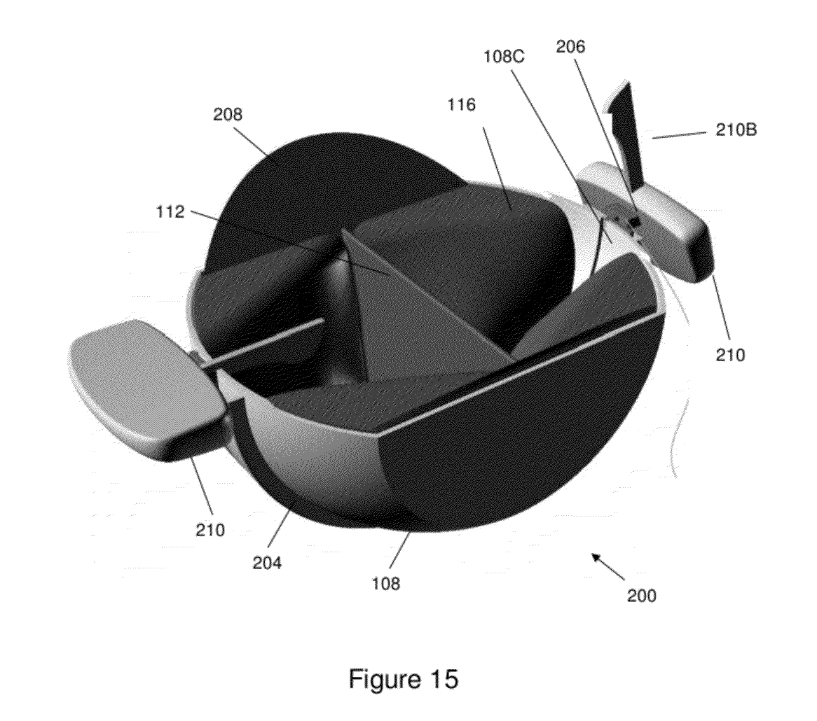

FIGS. 15-19 illustrate another embodiment of a food shaping device 200 according to the present invention. The food shaping device 200 is generally similar to the previously described device 100 in its construction and operation, including two arms 210 that can be depressed in a downward, arcing motion along a bottom surface of the bowl 108 and relative to the middle blade 112 and shaping insert 116.

The arms 210 include a relatively rectangular portion sized for placement of a user's thumb or fingers. Blades 210B are generally elongated with a bump, lip or feature of increased depth at its free end. As seen best in FIG. 15, the arms 210 are mounted on a joint 206 which allows each arm 210 to be moved between a generally parallel orientation to a generally vertical position. Preferably, the joint 206 includes a mechanism for selectively locking the position of the arms 210 and thereby preventing vertical movement during operation (i.e., during depression).

As also seen in FIG. 15, the top side of the device includes two angled surfaces 208. Preferably, the angled surfaces 208 are positioned opposite to each other and have angles relative to the middle blade 112 between about 0 and 90 degrees and more preferably between 10 and 80 degrees. These angled surfaces 208 provide support for a cookie and also promote folding of the cookie between the arms 210.

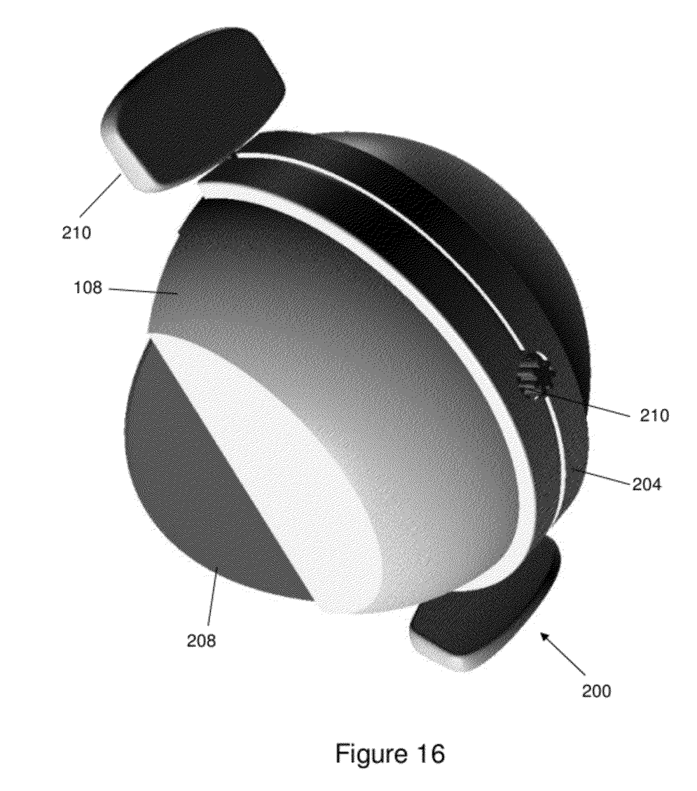

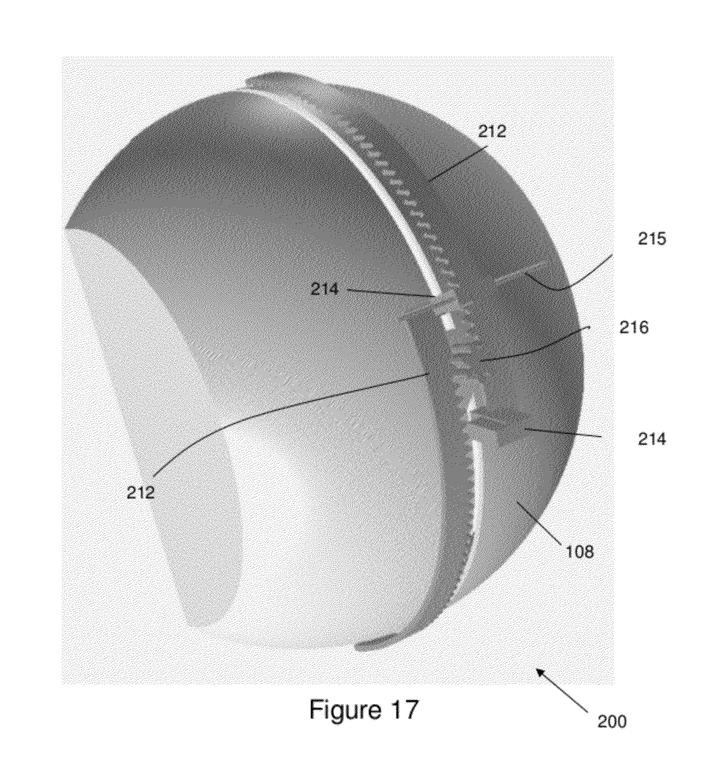

The arms 210 are mounted via hinges 206 on a gear mechanism located in the channeled enclosure 204 (seen in FIG. 16). FIG. 17 shows the various components of this mechanism (the enclosure 204 removed), including two elongated members 212 and a rotating center gear 216. The hinges 206 are preferably mounted to the ends of the elongated members 212 that are nearest top opening or rim of the bowl 108, thereby allowing the arms 210 to move with their respective elongated member 212. Additionally, the elongated members 212 have a curvature along their length that is similar to or substantially identical to the curvature of the bottom of the bowl 108, allowing the members 212 to move relative to the bowl, but maintain the same height or spacing relative to the bowl's surface.

Both elongated members 212 have a geared surface oriented towards the middle of the bowl 108 and engaging the rotating center gear 216. In this respect, the movement of both elongated members 212 is synchronized by the rotating center gear 216. The position of the elongated members 212 against the lower surface of the bowl 108 is maintained by spacer members 214 and spacer pin 215 located at the inner ends of the members 212 (i.e., the ends opposite those attached to the arms 210). These spacer members 214 and pin 215 take up the cross sectional space within the enclosure 204 and press against the enclosure's interior walls.

As the user presses down on the arms 210, the elongated members 212 move in opposite directions, synchronized by the center gear 216. This movement allows the larger, thumb region of the arms 210 to generally follow the lower contour of the bowl 108, thereby rotating or reorienting the blade 210B.

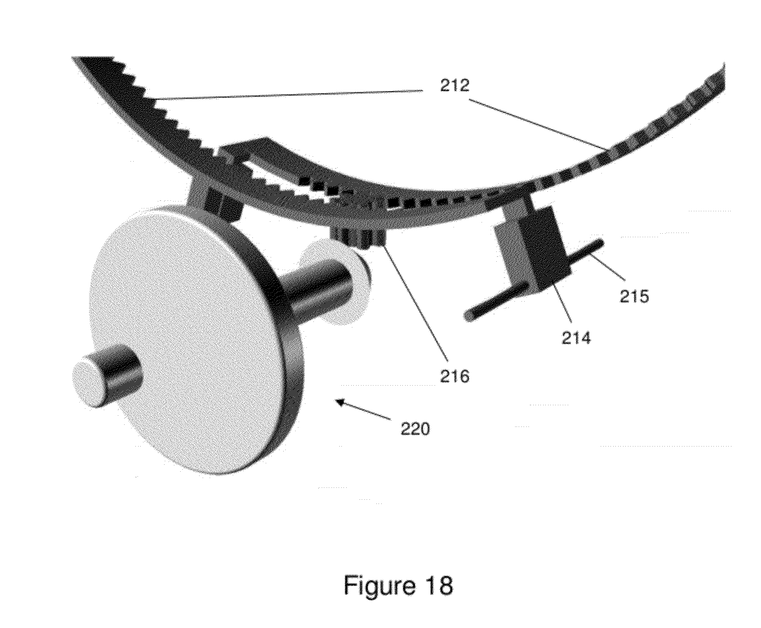

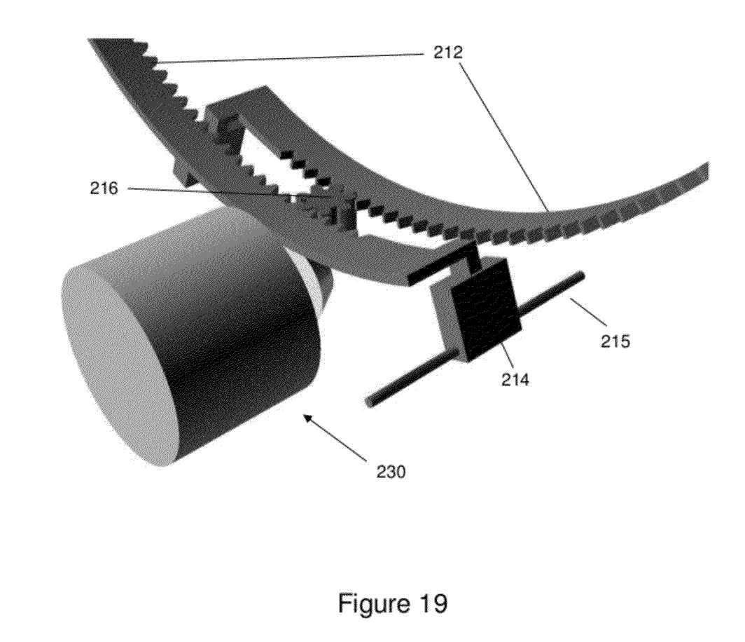

As seen in FIG. 18, a crank handle 220 can optionally be connected to the center gear 216, allowing a user to rotate the crank 216 to move the arms 210. A motor 230 can similarly be connected, as seen in FIG. 19, to allow for motorized operation of the device 200.

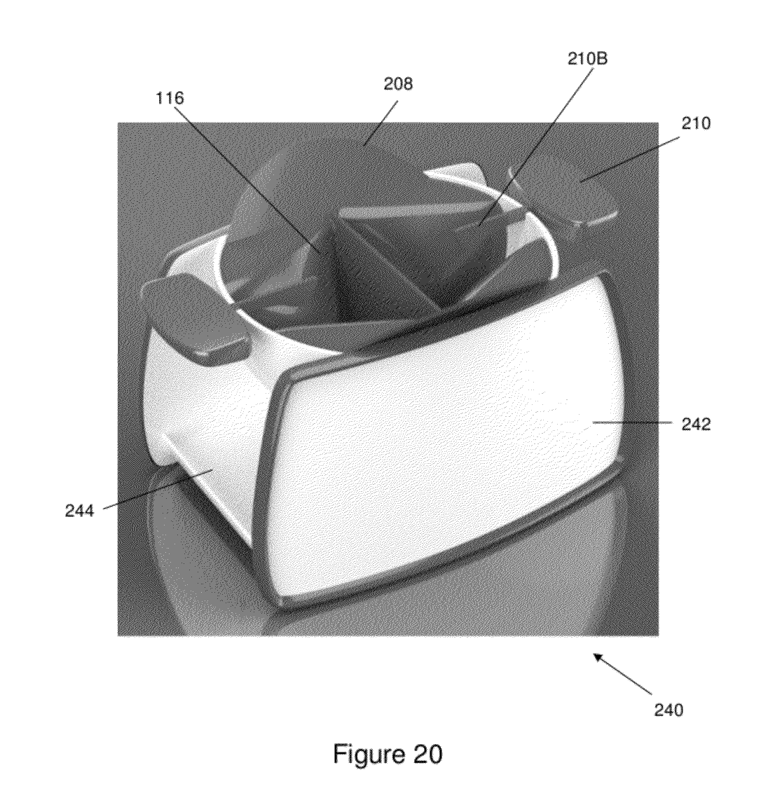

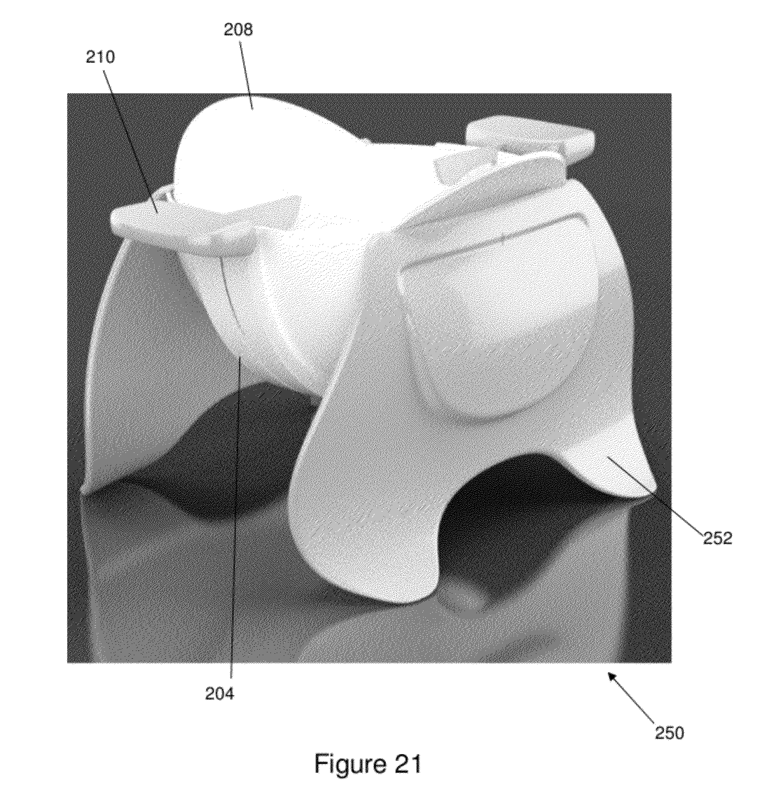

It should be understood that the device 200 can be used with a variety of different support structures. For example, FIG. 20 illustrates a device 240 with two generally flat, parallel support walls 242 that are connected by a lower, perpendicular base 244. In another example seen in FIG. 21, a device 250 includes two parallel support walls 252 that each has an inward curve or bow.

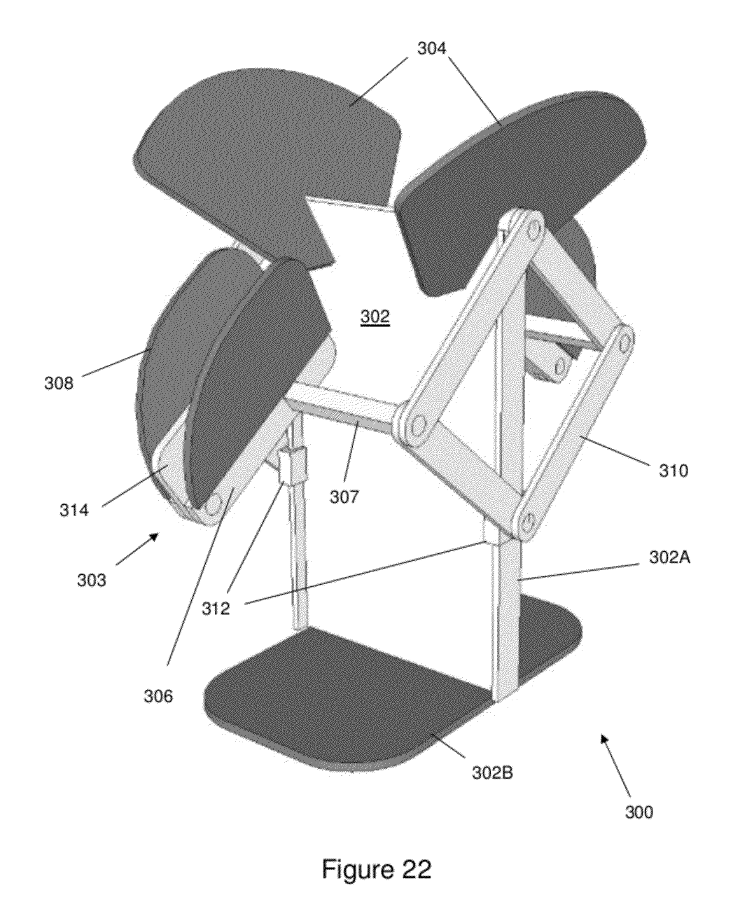

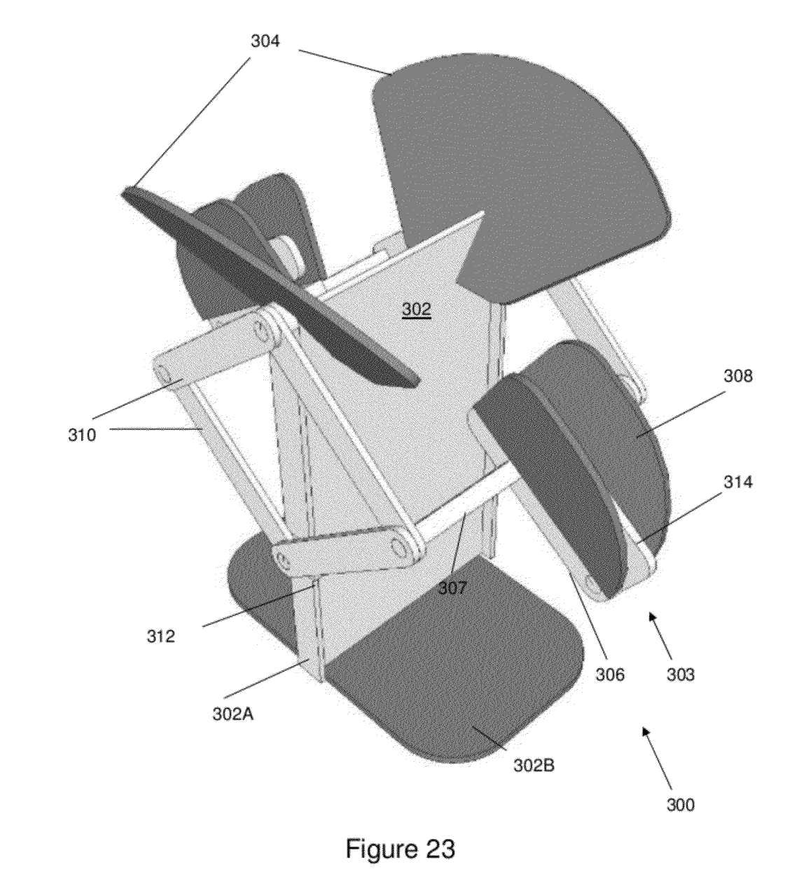

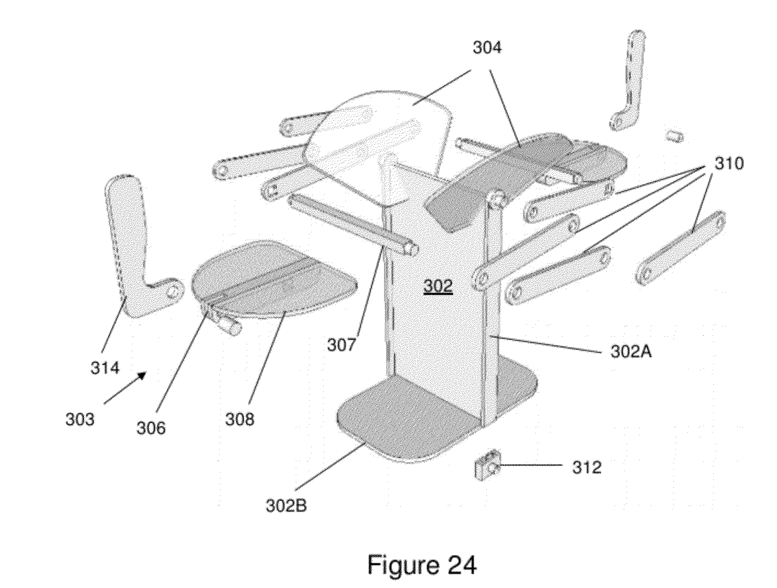

FIGS. 22-25 illustrate yet another embodiment of a food shaping device 300 according to the present invention. Generally, this device 300 is configured to shape food, such as a cookie, with movements generally similar to the previously described devices. However, a different mechanism is used to achieve this movement.

More specifically, the device 300 includes four arms 310 on opposing sides of the device 300 that lower and rotate two support members 306 by sliding on an elongated track 302A. The arms 310 are pivotally connected to each other to form a generally diamond or flattened shape (depending on the state of use). The “top” of the diamond formed by the arms 310 is pivotally mounted in place at the top of an elongated track 302A while the “bottom” of the diamond is connected to a sliding member 312 that engages and vertically slides on the track 302A. In this respect, the diamond shape can generally flattened (i.e., the sliding member 312 moved towards the pivotally mounted top) or the diamond shape can be generally narrowed (i.e., the sliding member 312 moved away from the pivotally mounted top).

The “sides” of the diamond shape are connected to a crossbar 307. Preferably, the crossbar 307 is captured or prevented from rotating relative to at least one of the arms 310 (e.g., a square shaped end that enters a square aperture in the arm 310). In this respect, the crossbar 307 rotates in unison with the arms 310.

The crossbar 307 supports two shaping assemblies 303 that allow the user to support and fold a food item, such as a cookie, in two directions. The shaping assembly 303 includes a base member 306 that is non-rotatively coupled to the crossbar 307, two opposing flaps 308 and a hinged arm 314. The flaps 308 are adjustable, via a hinge connection to the base member 306, but can also be mounted at a fixed position (e.g., 45 degrees). The hinged arm 314 is preferably aligned with the base member 306 and can move between a perpendicular and parallel position relative to the base member 306.

Finally, a center blade 302 is supported at its bottom by a perpendicular base 302B and includes two opposing shaping flaps 304 near its top. The shaping flaps 304 are preferably angled relative to the top of the blade 302 between angles of 0 and 90 degrees and more preferably between 20 and 70 degrees.

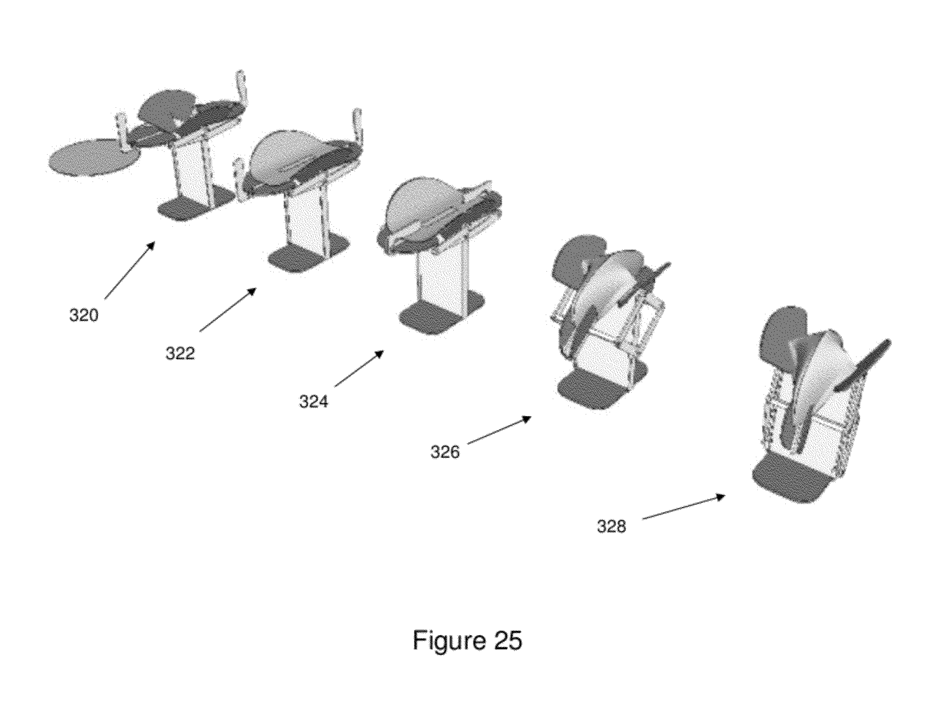

FIG. 25 illustrates various positions of the device 300 when shaping an item of food such as a cookie. In position 320, the shaping assemblies 303 are moved to an elevated position, the flaps 308 are moved to a generally flat position and the hinged arm 314 is adjusted to a perpendicular position, relative to the base member 306.

In position 322, a cookie is placed on top of the shaping assemblies 303, flaps 304 and blade 302. At this time, a paper with printed message (e.g., a fortune) or other items, can be placed on the top of the cookie to be included inside the final folded cookie shape.

In position 324, the arms 314 are moved to a generally parallel or horizontal position relative to the base member 306. In position 326, the flaps 308 are moved towards each other, causing the cookie to bend along a first direction. The user also moves the shaping assemblies 303 downward.

As seen in position 328, the shaping assemblies 303 move the end of the folded cookie downward and inward in a generally arcing motion. This movement forces the middle of the cookie against the blade 302. In this respect, a second fold is created perpendicularly to the first fold. Hence, the final cookie shape is that of a traditional fortune cookie.

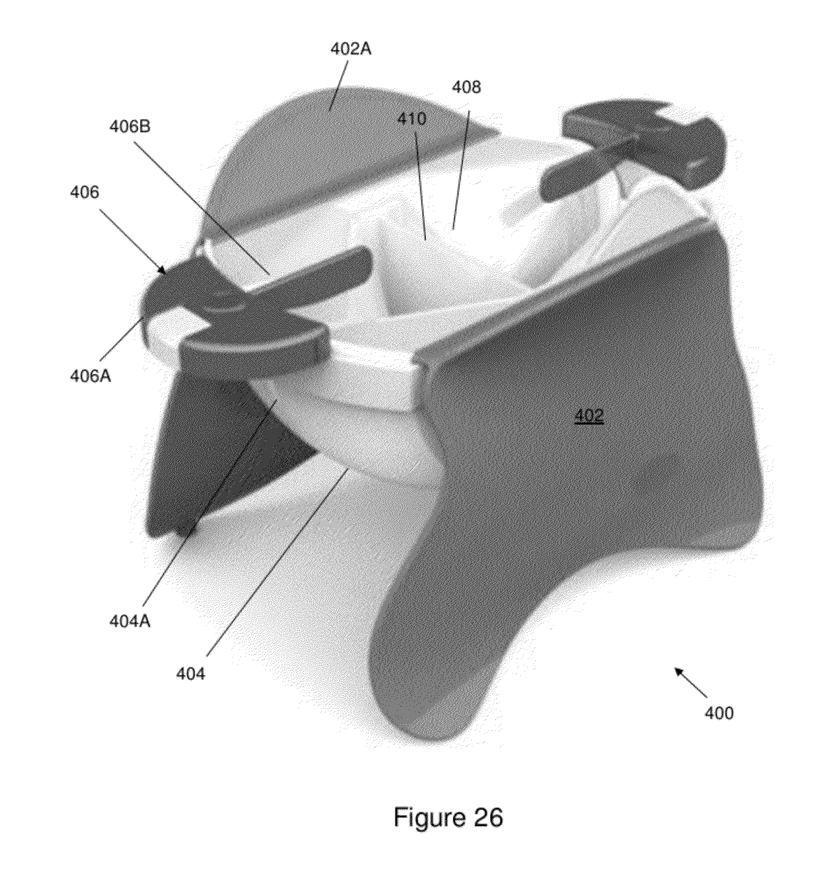

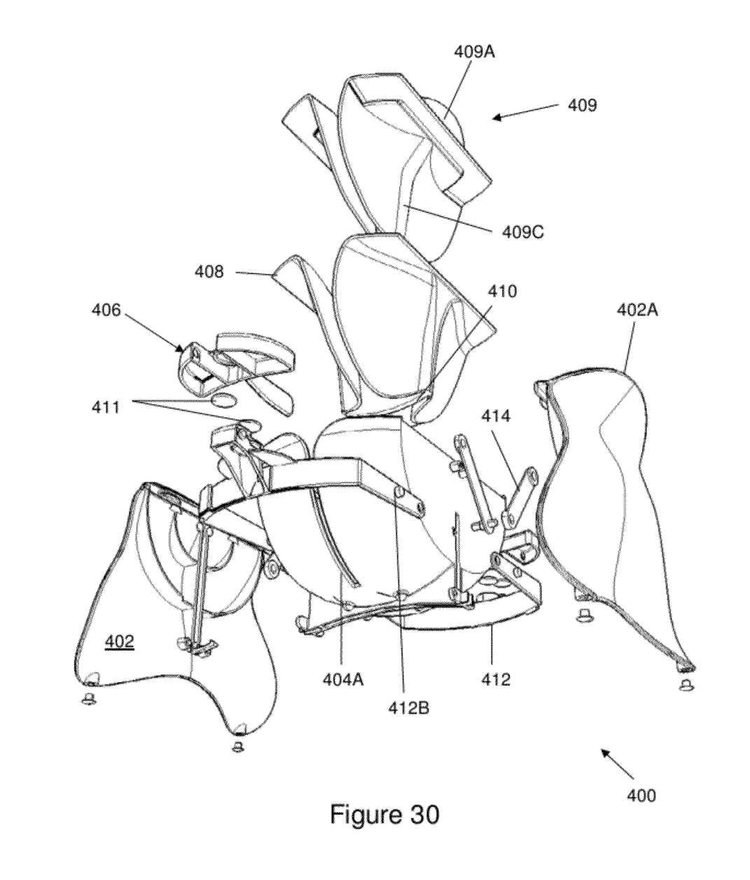

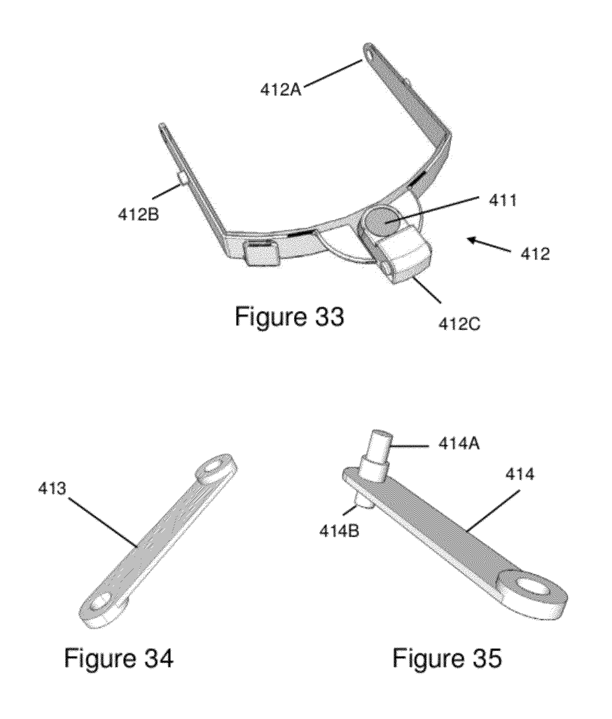

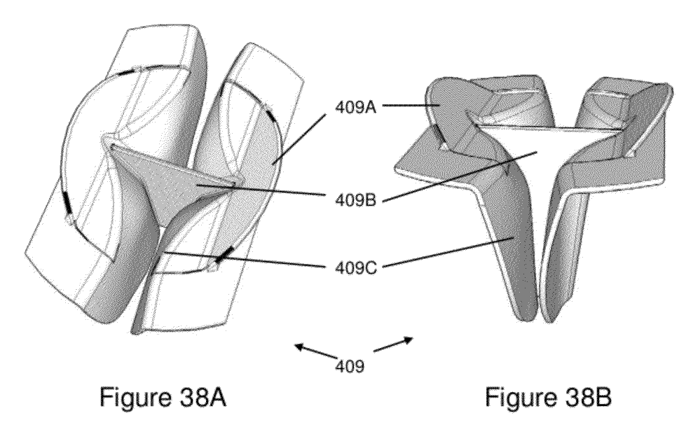

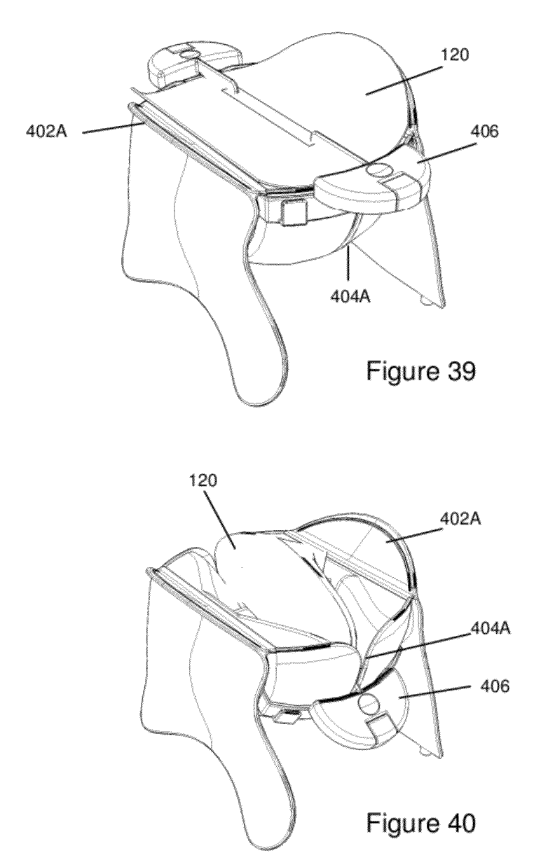

FIGS. 26-42 illustrate aspects of yet another embodiment of a food shaping device 400 that is generally similar to the previously described embodiments. For example, the device 400 includes two arms 406 with blades 406B that can move downward and inward (e.g., pivot downwardly along an arc-like path) to follow a slot or passage 404A in the bowl 404, thereby causing a cookie 120 placed on top of the device 400 to bend in a first direction aligned with the blades 406B and a second direction aligned with a center blade 410 (see FIGS. 39-42).

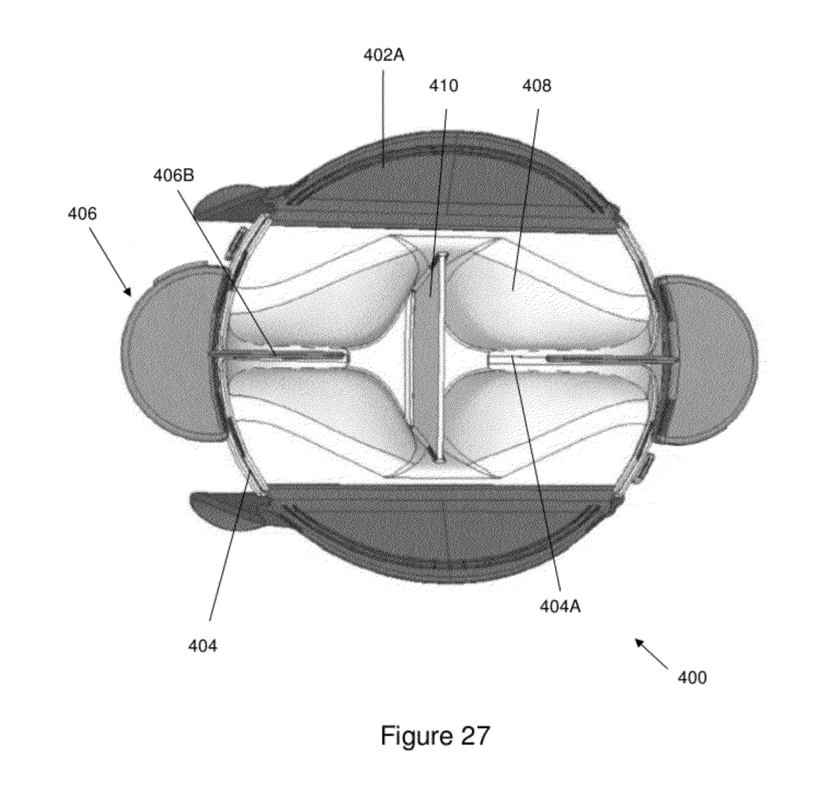

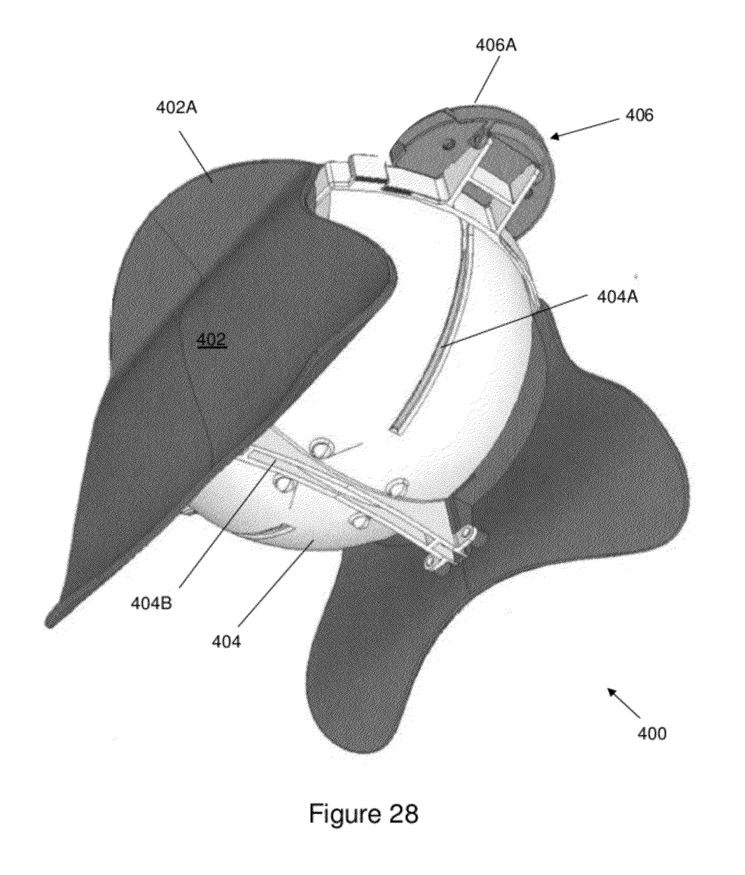

The bowl 404 is supported by shaped side panels 402 that have an angled top panel 402A to support a cookie and promote a desirable folded shape. The panels 402A may also include a curved ridge along its out edge (seen in FIG. 27) to help guide and retain a user's placement of a cookie 120. As best seen in FIG. 28, a bridge member 404B connects the panels 402 to each other and to the bottom of the bowl 404.

As best seen in FIGS. 27, 29, 30, 37A, 37B, 38A and 38B the device 400 also includes a large shaping insert 408 and a small shaping insert 409 that are generally similar to those previously described in this specification. In one embodiment, each shaping insert 408 and 409 separately and removably fit within bowl 404. In another embodiment, the small insert 409 is shaped to fit over and sit on top of the large insert 408.

The shaping inserts 408 and 409 are generally further spaced apart near the center blade 410 and 409B than near the outer edge of the device 400. Additionally, the shaping inserts 408 and 409 are generally wider near the top of the device and become narrower along the depth of the device 400. Described another way, the inserts 408, 409 have two opposing convex portions on each side of the blade 410. In other words, the inserts 408, 409 have a generally complimentary or mating shape to that of a traditional fortune cookie shape.

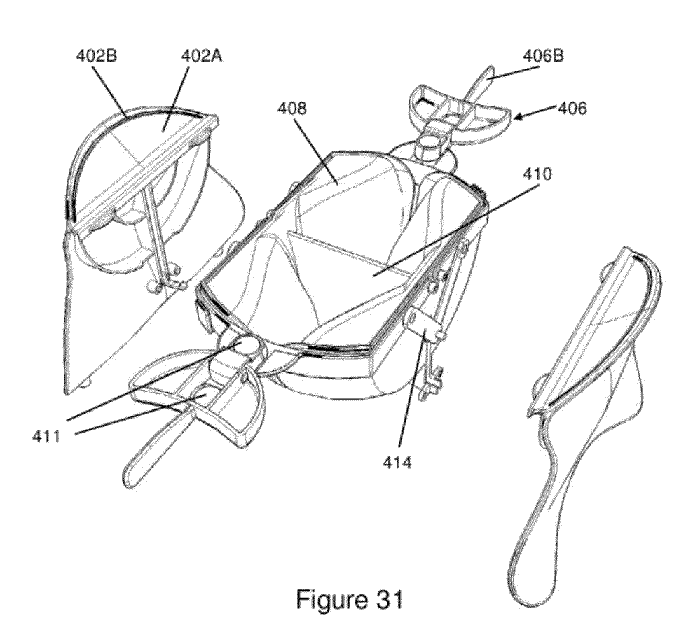

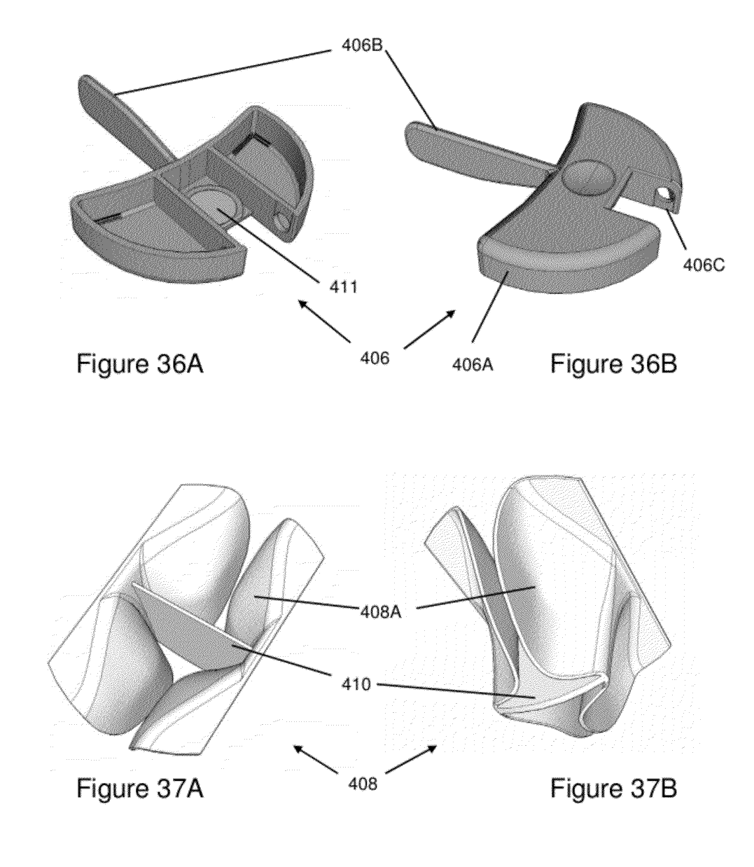

Preferably, the arms 406 can rotate upwards via a hinge mechanism seen best in FIGS. 28, 29, 30, 31, 33, 36A and 36B. This upward or rotating movement can preferably be locked in a horizontal position by a releasable lock mechanism. The lock mechanism is preferably composed of two opposing apertures 406C located in a recessed area of the body portion 406A of the arm 406 (seen best in FIGS. 36A and 36B). These apertures fit on to mating posts on area 412C of the frame members 412, allowing pivotal movement of the arms 406. The arms 406 are preferably maintained in a level, horizontal position by two magnets 411 that are each located on the underside of the arms 406 and on a top surface of the frame member 412. Both magnets 411 are preferably aligned with each other an oriented in opposite polar positions so as to attract each other. Preferably, the attraction of the two magnets 411 is sufficient to maintain the arms 406 in their horizontal position during folding (e.g., the magnets provide about 3 lbs of force). In this regard, the arms 406 can be prevented from unintentionally flipping upwards during folding, yet can be pivoted back (e.g., FIG. 31) to allow a cookie to be placed on top of the device 400.

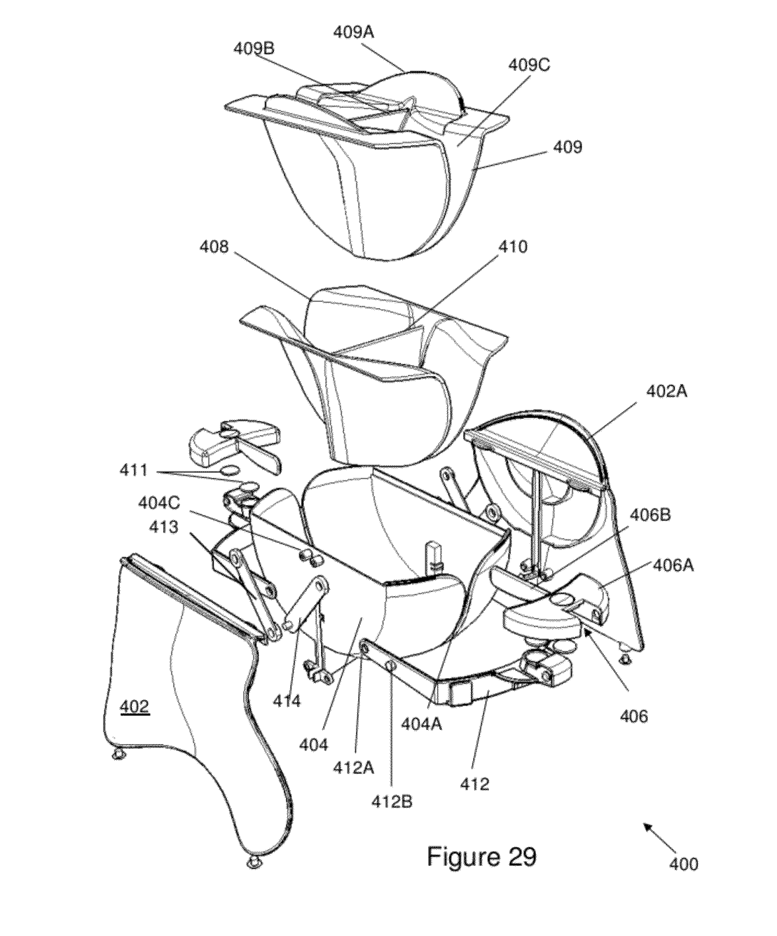

The movement of the arms 406 is controlled by a pivoting framework, seen in FIGS. 29, 30, 32A, 32B, 32C 33, 34 and 35. The framework includes two opposing frame members 412 that have a generally U shape and are pivotally mounted at apertures 412A on pegs 404C near the middle of the bowl 404. The frame members 412 are sized and shaped such that as they pivot downwards, they maintain a relatively uniform distance from the bottom of the bowl 404, thereby also maintaining the arms 406 at a relatively constant distance from the bottom of the bowl 404. In other words, the frame members 412 are preferably shaped and mounted such that the bowl 404 does not interfere with their downward pivoting movement.

The movement and maximum raised position of frame members 412 is preferably limited by arms 413 and 414. The arms 413, 414 each connect to posts 412B of the frame member 412 at one end and pivotally connect to each other at their opposing ends (i.e., to form a V-shape). Arm 414 includes a first post 414A on one side and a second post 414B in an opposing position on the opposite side of the arm 414. The second post 414B pivotally engages an aperture of arm 413, allowing the arms to pivot relative to each other.

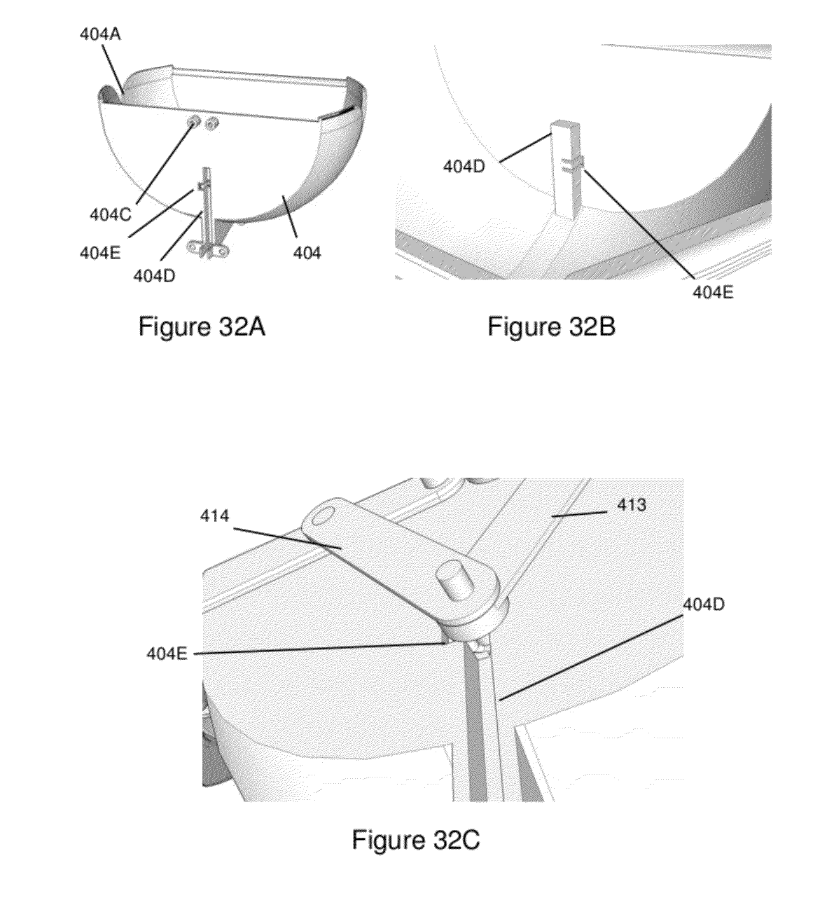

The first post 414A engages a recessed track 404D (seen best in FIGS. 32A, 32B and 32C) which guides the post 414A (and thus arms 413 and 414) downwards as the frame members 412 are pushed downwards. In this respect, the track 404D ensures that both frame members 412 move downward in unison. Preferably, the track 404D includes a detent or snap area 404E which selectively retains the first post 414A in an elevated position. In one example, this snap area 404E may include one or more bendable pins or other irregular shape. Hence, the snap area 404E can maintain the arms 406 and frame members 412 to maintain their horizontal position, yet further allow a user to overcome this retaining force by applying downward pressure on the arms 406.

In operation, the device 400 operates in much the same manner as the previously discussed embodiments. For example, the arms 406 are unlocked and rotated/raised so that the blades 406B are moved away from the top surface of the device 400 (e.g., the blades 406B are pivoted to 90, 180 or more degrees relative to the surface on which the device sits). A round cookie is placed over a top of the device 400, resting on the angled fins 402A and the center blade 410 (seen in FIG. 39). The arms 406 are moved back into a generally level or horizontal position so that the magnetic locking mechanism again locks the pivotal orientation of the arms 406.

Next, the user pushes down the arms 406 by applying pressure with their thumbs or fingers on the top of arm body 406A, as seen in FIG. 40. The arms 406 move downward in an arc path that generally mirrors the bottom curve of the bowl 404. In other words, the arms 406 move in a generally pivotal or with a rotational component (i.e., body 406A moves downward faster than the blade 406B). The blades 406B press the cookie downward against the convex surfaces of the contoured insert 408, forming a fold in the cookie 120 that is aligned along the blades 406B (FIG. 40).

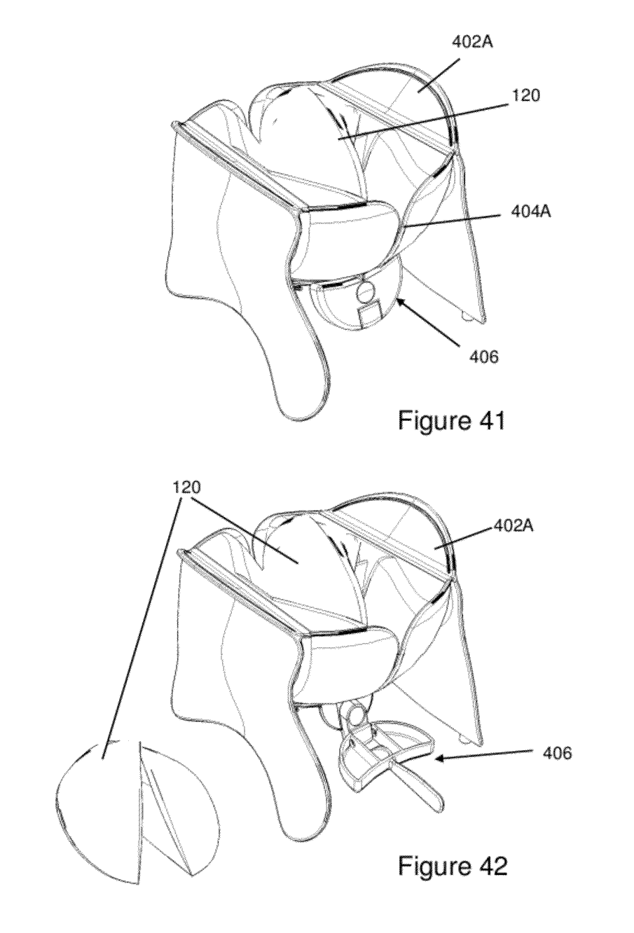

As seen in FIG. 41, the blades 406B also pull the cookie 120 against the center blade 410 and thereby cause a second fold to form that is generally perpendicular to the first and aligned along the length of the blade 410. In this respect, a traditional fortune cookie shape is created. Finally, the arms 406 are pivoted backwards, removing the blade 406B from the interior of the folded cookie 120, allowing the use to remove the cookie 120 from the machine 400 (FIG. 42).

It should be understood that various features and elements of the previously described embodiments can be added, interchanged or removed with other embodiments according to the present invention. For example, the flaps 402A or arm assembly 406 may be added to the device 100.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A food folding device comprising:
a base having a top surface shaped to support a food item and a bottom surface;
two elongated arm members disposed at opposing sides of said base; and
a fold-inducing member disposed on said base between said two arm members;
wherein said two elongated arm members are movable along a downward arcing path towards said bottom surface.

2. The food folding device of claim 1, wherein said two elongated arm members are pivotally connected to said base.

3. The food folding device of claim 1, further comprising a plurality of convex surfaces located on said base.

4. The food folding device of claim 3, wherein said plurality of convex surfaces are located on opposite sides of said two elongated arm members.

5. The food folding device of claim 1, further comprising a linkage mechanism connected to said two elongated arm members maintaining substantially simultaneous movement of said two elongated arm members.

6. The food folding device of claim 1, wherein each of said elongated arm members include a body portion sized for contact and downward pressure from human thumbs.

7. The food folding device of claim 1, wherein each of said two elongated arm members are further connected to said base via a movement mechanism; said movement mechanism arranged to selectively move said two elongated arm members away from said top surface of said base.

8. The food folding device of claim 1, comprising a first insert that is removably positionable in said base; said first insert comprising at least two convex surfaces.

9. The food folding device of claim 1, wherein said two elongated arm members are hingedly attached to said food folding device and magnetically biased to a generally horizontal orientation.

10. A food folding device comprising:
a base having a top surface shaped to support a food item and a bottom;
two elongated members connected at opposing sides of said base and movable towards said bottom of said base; and,
a plurality of convex, contoured surfaces disposed on said base.

11. The food folding device of claim 10, wherein said plurality of convex, contoured surfaces further comprise a first convex surface opposing a second convex surface, and a third convex surface opposing a further convex surface.

12. The food folding device of claim 10, wherein said two elongated members are movable between said plurality of convex, contoured surfaces.

13. The food folding device of claim 10, further comprising a blade positioned perpendicularly relative to an alignment of said two elongated members.

14. The food folding device of claim 10, wherein said plurality of convex, contoured surfaces comprise an insert member that is removably positioned in said base.

15. A method of operating a food folding device comprising:
placing a food item on a surface of said food folding device;
depressing two elongated members against said food item;
urging said food item against a contoured surface of said food folding device; and,
creating a first fold and a second fold in said food item; said second fold being generally perpendicular to said first fold.

16. The method of operating a food folding device of claim 15, further comprising urging said food item against a blade member.

17. The method of operating a food folding device of claim 16, wherein said depressing two elongated members further comprises pivotally moving said two elongated members in unison.

18. The method of operating a food folding device of claim 15, wherein each of said two elongated members have a narrow region and a wide region; and wherein said depressing two elongated members further comprises pressing a human finger against said wide region of each of said elongated members.

19. The method of operating a food folding device of claim 15, wherein said placing a food item on a surface of said food folding device further comprises moving said two elongated members away from said surface of said food folding device.
